(19) United States
(12) Patent Application Publication
(10) Pub. No.: US 2025/0225412 A1
(43) Pub. Date: Jul. 10, 2025

(54) Next generation Artificial intelligence agents

(71) Applicant: Zscaler, Inc., San Jose, CA (US)

(72) Inventors: Claudionor Jose Nunes Coelho, Jr., Redwood City, CA (US); Guangyu Zhu, San Jose, CA (US); Hanchen Xiong, London (GB); Tushar Karayil, Hyderabad (IN); Sree Koratala, San Jose, CA (US); Rex Shang, San Jose, CA (US); Jacob Bollinger, San Francisco, CA (US); Mohamed Shabar, Redmond, WA (US); Syam Nair, Seattle, WA (US)

(73) Assignee: Zscaler, Inc., San Jose, CA (US)

(21) Appl. No.: 18/640,582

(22) Filed: Apr. 19, 2024

Related U.S. Application Data
(60) Provisional application No. 63/619,349, filed on Jan. 10, 2024.

(30) Foreign Application Priority Data
Mar. 7, 2024 (IN) 202441016399

(51) Int. Cl. G06N 5/04

(52) U.S. Cl. CPC G06N 5/04

(57) ABSTRACT

Systems and methods for next generation artificial intelligence agents include operating an Artificial Intelligence (AI) agent system that includes an agent core connected to memory, one or more tools, and a planner; receiving a request from a user; utilizing the planner to break the request down into a plurality of sub-parts that are each individually simpler than the request; and generating an answer to the request using the plurality of sub-parts with the memory and the one or more tools.

### CROSS-REFERENCE TO RELATED APPLICATION(S)

The present disclosure claims priority to U.S. Provisional Patent Application No. 63/619,349, filed Jan. 10, 2024, the contents of which are incorporated by reference in their entirety.

### FIELD OF THE DISCLOSURE

The present disclosure generally relates to machine learning and artificial intelligence. More particularly, the present disclosure relates to systems and methods for next generation artificial intelligence agents.

### BACKGROUND OF THE DISCLOSURE

Machine learning and Artificial Intelligence (AI) techniques are proliferating, and we are experiencing a technological revolution. What began as interacting agents quickly started moving to indexing documents (Retrieval-Augmented Generation (RAG)), and now, indexing documents, connecting to data sources, and enabling data analysis with a simple sentence. There have been a lot of promises for delivering Large Language Models (LLMs), but few of these promises have been fulfilled. Some of the important reasons for that are (1) We are building AI agents, not LLMs, (2) People are treating the problem as a research problem, not an engineering problem, (3) Bad data, (4) large computation requirements, etc. See, e.g., Claudionor N. Coelho et al., “The myth of large language models,” VentureBeat, Jan. 17, 2024, available online at venturebeat.com/ai/the-myth-of-large-language-models.

### BRIEF SUMMARY OF THE DISCLOSURE

The present disclosure relates to systems and methods for next generation artificial intelligence agents. AI agents provide a way to link LLMs with backend systems. An AI Agent encompasses a system that employs an LLM to process and reason about a specific domain. To generate specific answers (often related to the domain), the AI Agent leverages auxiliary systems in conjunction with the LLM. These auxiliary systems support the agent in comprehending the domain and facilitating the creation of accurate responses. AI Agents can include four major components. The agent core forms the central component and is responsible for orchestrating the agent's overall functionality. The memory module enables the agent to store and retrieve relevant information, enhancing its ability to retain context and make informed decisions. The planner component guides the agent's actions by formulating a strategic course of actions based on the given problem or task. Finally, the set of tools encompasses various external components and resources that assist the agent in performing specific tasks or functions within the defined domain. These components collaboratively enable AI Agents to effectively process information, reason, and generate responses in a manner aligned with their designated purpose.

The present disclosure includes next generation artificial intelligence agents via an Artificial Intelligence (AI) agent system that includes an agent core connected to memory, one or more tools, and a planner; receiving a request from a user; utilizing the planner to break the request down into a plurality of sub-parts that are each individually simpler than the request; and generating an answer to the request using the plurality of sub-parts with the memory and the one or more tools.

The present disclosure also includes detecting and fixing collisions in Artificial intelligence agents via steps that include, responsive to obtaining a plurality of tuples in a Retrieval-Augmented Generation (RAG) system with each tuple including a first value and a second value, generating a plurality of different first values from a corresponding first value where the plurality of different first values are similar to the corresponding first value; determining top-k, k is an integer greater than or equal to one, matches for the plurality of different first values to the second values in the RAG system; determining a confusion matrix based on the top-k matches; and utilizing the confusion matrix to debug the RAG system.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of an AI agent.

FIG. 2 is a logical diagram of an AI platform that can provide AI functionality with one or more cloud services.

FIG. 3 is a logical diagram of an example AI copilot system, which utilizes the AI agents of FIG. 1 and the AI platform of FIG. 2.

FIG. 4 is a flow diagram of functionality in the AI copilot system of FIG. 3, in the example use case of user monitoring.

FIG. 5 is a flowchart of a user story for an example to order pizza via a food app.

FIG. 6 is a flowchart of an AI agent process,

FIG. 7 is a flowchart of a process for detecting and fixing collisions in a RAG system.

FIG. 8 is a table of an example confusion matrix used in the process of FIG. 7.

FIG. 9 is a block diagram of a processing device.

### DETAILED DESCRIPTION OF THE DISCLOSURE

Again, the present disclosure relates to systems and methods for next generation AI agents. In this disclosure, we examine the role of AI agents as a way to link LLMs with backend systems. Then, we look at how the use of intuitive, interactive semantics to comprehend user intent can set up AI agents as the next generation user interface and user experience (UI/UX). Finally, with upcoming AI agents in software, we show why we need to bring back some principles of software engineering that people seem to have forgotten in the past few months.

The next generation AI agents described herein can be used as a copilot for cloud services, including cybersecurity services. Some specific areas include:

TABLE 1
Generative AI feature and Software-as-a-Service (SaaS) procurement.
Use Case evaluation and Return on Investment (ROI) evaluation.
Project Portfolio Management.
Perform exploratory data analysis to understand ecosystems, behavioral trends, and long-
term trends.
Build machine learning models (training, validation, and testing) with appropriate solutions
for data reduction, sampling, feature selection, and feature engineering.
Design and evaluate experiments (including hypothesis testing) by creating key data sets.
Apply data mining or NLP techniques to cleanse and prepare large data sets.
Defining and socializing best practices.
Regularly measure analytics.
Create and maintain production models and related applications.
Develop enterprise Advanced Analytics, AI/ML as a service and MLOps strategy.
Develop Data Platform enhancements or vendor selection requirements for AI/ML
workbench/platform.
Improve predictive models with data from multiple models.
Automate feedback loops for algorithms/models in production.
Create repeatable processes and scalable data products.
Influence functional teams and develop best practices across the organization.
Review, scale, and enhance operationalized statistical models and algorithms.
Other use cases include, but are not limited to: account scoring, propensity to buy,
customer segmentation, sentiment analysis, customer churn and uplift prediction,
hypothesis testing and forecasting models.

### I Want a Pizza in 20 Minutes

LLMs offer a more intuitive, streamlined approach to UI/UX interactions compared to traditional point-and-click methods. To illustrate this, suppose you want to order a “gourmet margherita pizza delivered in 20 minutes” through a food delivery app. This seemingly straightforward request can trigger a series of complex interactions in the app, potentially spanning several minutes of interactions using normal UI/UX. For example, you would probably have to choose the “Pizza” category, search for a restaurant with appetizing pictures, check if they have margherita pizza, and then find out whether they can deliver quickly enough—as well as backtrack if any of your criteria are not met.

We Need More than LLMs

LLMs are AI models trained on vast amounts of textual data, enabling them to understand and generate remarkably accurate human-like language. Models such as OpenAI's GPT-3 have demonstrated exceptional abilities in natural language processing, text completion, and even generating coherent and contextually relevant responses.

Although more recent LLMs can do data analysis, summary, and representation, the ability to connect external data sources, algorithms, and specialized interfaces to an LLM gives it even more flexibility. This can enable it to perform tasks that involve analysis of domain-specific real-time data, as well as open the door to tasks not yet possible with today's LLMs.

This “pizza” example illustrates the complexity of natural language processing (NLP) techniques. Even this relatively simple request necessitates connecting with multiple backend systems, such as databases of restaurants, inventory management systems, delivery tracking systems, and more. Each of these connections contributes to the successful execution of the order.

Furthermore, the connections required may vary depending on the request. The more flexibility one necessitates from the system, the more connections it needs with different backends. This flexibility and adaptability in establishing connections is crucial to accommodate diverse customer requests and ensure a seamless experience.

### AI Agents

LLMs serve as the foundation for AI agents. According to their definition, an AI agent is a sophisticated system that employs an LLM to process and reason about a specific domain. To generate an answer, the AI agent leverages auxiliary systems in conjunction with the LLM. These auxiliary systems support the agent in comprehending the domain and facilitating the creation of accurate responses.

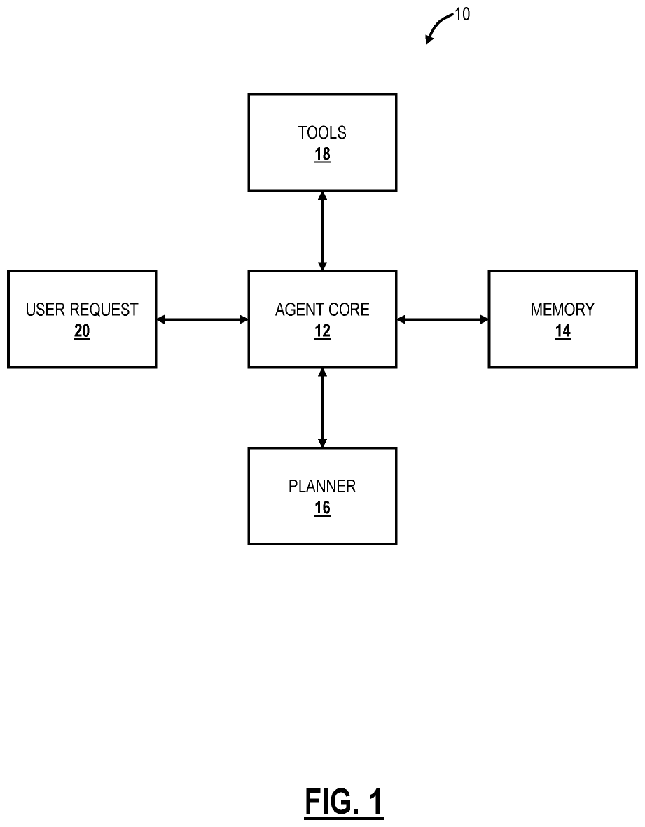

FIG. 1 is a block diagram of an AI agent 10. The AI agent 10 includes several integral components or modules, such as an agent core 12, a memory module 14, a planner component 16, tools 18, and a user request 20. Note, these components or modules 12, 14, 16, 18, 20 are implemented via compute resources. The agent core 12 forms the central component and is responsible for orchestrating the agent's 10 overall functionality. The memory module 14 enables the agent 10 to store and retrieve relevant information, enhancing its ability to retain context and make informed decisions. The planner component 16 guides the agent's 10 actions by formulating a strategic course of action based on the given problem or task. Various additional tools 18 and resources assist the agent in performing specific tasks or functions within the defined domain. The user request 20 provides the UI/UX interface to the agent 10. These components collaboratively enable AI agents 10 to effectively process information, reason, and generate responses in a manner aligned with their designated purpose.

### Agent Core

The agent core 12 plays a central role in orchestrating the AI agent's 10 overall functionality. It serves as the control center, managing decision-making processes, communication, and coordination of various modules and subsystems within the agent 10. The primary function of the agent core 12 is to facilitate the seamless operation of the AI agent 10 and ensure efficient interaction with the environment or the tasks at hand.

The agent core 12 acts as the interface between the AI agent 10 and its surroundings. It receives inputs from the environment or external systems, processes the information, and generates appropriate actions or responses. This involves employing various algorithms, heuristics, or decision-making mechanisms to analyze the received data and determine the best course of action. The agent core 12 also handles the coordination of different modules and subsystems within the AI agent 10, ensuring that they work in harmony to achieve the agent's 10 objectives.

Furthermore, the agent core 12 is responsible for managing the agent's 10 internal state. It maintains a representation of the agent's knowledge, beliefs, and intentions, allowing it to reason, plan, and adapt its behavior accordingly. The agent core 12 oversees the update and retrieval of information from the agent's 10 memory 14, enabling it to access relevant knowledge and contextual information during decision-making processes.

Overall, the agent core 12 acts as the brain of an AI agent 10, providing the intelligence, coordination, and control to enable the agent 10 to effectively interact with the environment and perform tasks within the defined domain. It governs the decision-making, communication, and coordination processes, ensuring the agent 10 operates optimally and achieves its objectives.

### Memory

The memory module 14 encompasses two important aspects: history memory and context memory. These components work together to store and manage information critical to the agent's 10 operation, allowing it to make informed decisions and maintain a coherent understanding of the environment.

History memory serves as a repository for past interactions and experiences of the AI agent 10. It stores a record of previous inputs, outputs, and the outcomes of actions taken by the agent 10. This historical data enables the agent 10 to learn from past interactions and avoid repeating mistakes. By referring to the history memory, the agent 10 can gain insights into effective strategies, successful outcomes, and patterns in the data that can inform its decision-making process.

Context memory, on the other hand, focuses on maintaining a coherent understanding of the current situation. It stores relevant contextual information that provides the necessary background for the agent 10 to interpret and respond appropriately to the present state. This can include information about the environment, the user's preferences or intentions, and any other contextual factors that influence the agent's 10 behavior. By referencing the context memory, the agent 10 can adapt its actions and responses based on the specific circumstances, enhancing its ability to interact intelligently with the environment.

The integration of history memory and context memory allows the AI agent 10 to leverage both past experiences and current context to inform its decision-making process. By accessing historical data, the agent 10 can learn from its own actions and adjust its strategies accordingly. Simultaneously, the context memory ensures that the agent can adapt its behavior to the present situation, taking into account relevant contextual factors that may influence the decision-making process.

Overall, the memory module 14 serves as a crucial component for storing and managing information. By utilizing the stored data from past interactions and maintaining a coherent understanding of the current context, the agent 10 can make informed decisions, learn from experiences, and effectively navigate the complexities of its environment.

### Planner

The planner component 16 plays a crucial role in guiding the agent's 10 actions and formulating a strategic course of action based on the given problem or task. It is responsible for generating a sequence of steps or actions that lead the agent 10 towards achieving its objectives.

The planner component 16 analyzes the current state of the environment, along with any available information or constraints, to determine the most effective sequence of actions to achieve the desired outcome. It considers factors such as goals, resources, rules, and dependencies to generate a plan that optimizes the agent's 10 decision-making process.

An example of a prompt template that can be used by the planner is as follows.

### General Instructions

You are a domain expert. Your task is to break down a complex question into simpler sub-parts. If you cannot answer the question, request a helper or use a tool. Fill with Nil where no tool or helper is required.

### Available Tools

Search Tool
Math Tool

### Contextual Information

<information from Memory to help LLM to figure out the context around question>

### User Question

“How to order a margherita pizza in 20 min in my app?”

### Answer Format

{“sub-questions”: [“<FILL>”]}

The planner component 16 would then utilize this prompt template to generate a plan that outlines specific actions and steps to be taken.

By employing the planner component 16, the AI agent 10 can systematically determine the optimal sequence of actions to achieve its objectives, ensuring efficient decision-making and effective utilization of available resources. The generated plan serves as a roadmap for the agent's 10 actions, enabling it to navigate complex problem spaces and accomplish its goals in a strategic manner.

### Tools

In the AI agent 10, the set of tools 18 encompasses various resources and functionalities that assist in performing specific tasks or functions within the defined domain. Here is a list of possible tools 18 that can be utilized in the AI agent 10:
(1) RAG (Retrieval-Augmented Generation): RAG is a tool that combines retrieval-based methods with generative language models. It enables the agent 10 to retrieve relevant information from a knowledge base and utilize it to generate coherent and contextually appropriate responses.
(2) Database connections: Connecting to databases allows the AI agent 10 to access and retrieve information from structured data sources. This tool enables the agent 10 to query and extract relevant data for decision-making or generating responses.
(3) Natural Language Processing (NLP) libraries: NLP libraries provide a range of tools and algorithms for processing and understanding human language. These libraries offer functionalities such as text tokenization, named entity recognition, sentiment analysis, and language modeling, which can enhance the agent's language processing capabilities.
(4) Machine Learning frameworks: Machine learning frameworks, such as TensorFlow or PyTorch, provide tools and algorithms for training and deploying machine learning models. These frameworks enable the agent 10 to leverage various machine learning techniques, including supervised learning, unsupervised learning, or reinforcement learning, to enhance its capabilities.
(5) Visualization tools: Visualization tools assist in representing and interpreting data or model outputs in a visual format. These tools can help the agent 10 understand complex patterns, relationships, or trends in the data, aiding in decision-making and analysis.
(6) Simulation environments: Simulation environments provide a controlled virtual environment where the AI agent 10 can interact and learn without impacting the real world. These tools allow the agent to practice and refine its skills, test different strategies, and evaluate the potential outcomes of its actions.
(7) Monitoring and logging frameworks: Monitoring and logging frameworks facilitate the tracking and recording of agent activities, performance metrics, or system events. These tools assist in evaluating the agent's 10 behavior, identifying potential issues or anomalies, and supporting debugging and analysis.
(8) Data preprocessing tools: Data preprocessing tools help in cleaning, transforming, and preparing raw data before feeding it into the AI agent 10. These tools may include techniques for data cleaning, normalization, feature selection, or dimensionality reduction, ensuring the quality and relevance of data used by the agent 10.
(9) Evaluation frameworks: Evaluation frameworks provide methodologies and metrics to assess the performance and effectiveness of the AI agent 10. These tools enable the agent to measure its success in achieving objectives, compare different approaches, and iterate on its capabilities.

These tools, among others, contribute to the AI agent's 10 toolkit, empowering it with specialized functionalities and resources to perform specific tasks, process data, make informed decisions, and enhance its overall capabilities in the defined domain.

### Adding LLM-Based Intelligent Agents to Your Data is an Engineering Problem, not a Research Problem

People realized that natural language can make it much easier and forgiving (not to say relaxed) to specify use cases required for software development. Because the English language can be ambiguous and imprecise, this is leading to a new problem in software development, where systems are not well specified or understood.

### Bad Data

The cloud fulfilled the promise of not requiring data to be deleted, but just keeping data stored. With this, came the pressure to quickly create documentation for users. This created a “data dump”, where old data lives with new data, that old specifications that were never implemented are still alive, or even descriptions of functionalities of systems that have been outdated, but never updated in the documentation. Finally, documents seem to have forgotten what a “topic sentence” is, namely a sentence that expresses the main idea of the paragraph in which it occurs. Specifically, if we feed paragraphs into LLMs, we would like to extract the topic sentence.

LLM-based systems expect documentation to have well written pieces of text. Of note, OpenAI has stated that it is “impossible” to train AI without using copyrighted works. This alludes not only to the fact that we need a tremendous amount of text to train these models, but also that good quality text is required.

### RAG

This becomes even more important if you use RAG-based technologies (see Lewis, Patrick, et al. “Retrieval-augmented generation for knowledge-intensive NLP tasks.” Advances in Neural Information Processing Systems 33 (2020): 9459-9474, the contents of which are incorporated by reference in their entirety). In RAG, we index document chunks using embedding technologies in vector databases, and whenever a user asks a question, we return the top ranking documents to a generator LLM that in turn composes the answer. Needless to say, RAG technology requires well written indexed text to generate the answers.

RAG provides a pipeline which enables the combination of documents and algorithms in tools. In RAG, we index document chunks using embedding technologies in vector databases, and, whenever a user asks a question, we return the top ranking documents to a generator LLM that in turn composes the answer. Thus, RAG is the process of optimizing the output of an LLM, so it references an authoritative knowledge base outside of its training data sources before generating a response.

### Unified AI Agent Architecture for Cloud Services

Examples of cloud services include Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide cloud-based cybersecurity, namely Security-as-a-service through the cloud, including access control, policy enforcement, threat prevention, data protection, and the like. ZPA can include access control, segmentation, Zero Trust Network Access (ZTNA), etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs). Those of ordinary skill in the art will recognize various other types of cloud services are also contemplated.

The present disclosure addresses the application of using AI agents with cloud services, such as a copilot which is an AI assistant that allows a user to interact with the cloud service for a variety of tasks.

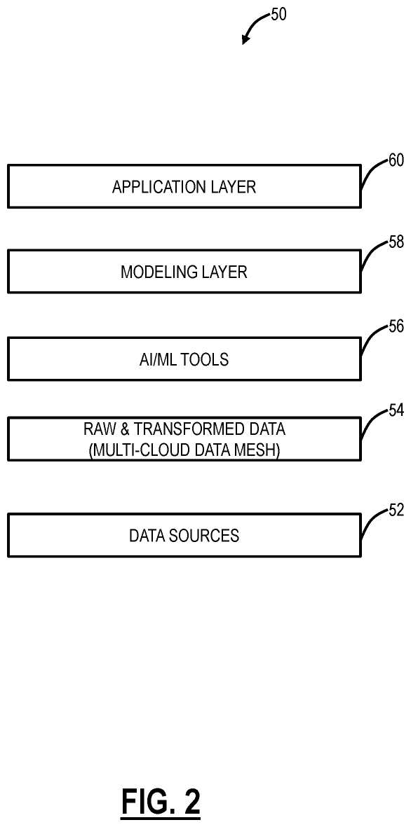

FIG. 2 is a logical diagram of an AI platform 50 that can provide AI functionality with one or more cloud services. The AI platform 50 can support multiple cloud services 50, such as for copilot functionality. The AI platform 50 is depicted in a logical manner in FIG. 2 and includes data sources 52, raw and transformed data 54, AI/ML tools 56, a modeling layer 58, and an application layer 60. The AI platform 50 can be realized as one or more AI agents 10, e.g., the application layer 60 can support the user request 20, the modeling layer 58 can be the agent core 12, the AI/ML tools 56 can be the tool 18, etc. The data sources 52 can include various data based on operations of the cloud services, product data, enterprise application data, third party data, web logs, other logs, and the like. The raw and transformed data 54 can include modified versions of the data in the data sources 52.

The AI platform 50, in an embodiment, can focus on providing model-based insights which help in understanding various aspects of business, customers, and products. In an embodiment, the AI platform 50 can provide generative AI Platform-as-a-Service. To start, various LLMs were used for providing functions related to cloud services. From this experience, it was determined that LLMs by themselves are not able to do much (in the sense that it hallucinates a lot), unless you fine tune it with your own data, fine tune it with instructions following capabilities (algorithms), connect to document sources to avoid hallucinations, or connect to data sources to enable better data analysis. That is, there is a need for AI agents 10, not merely LLMs.

The AI platform 50 is a unified foundation model for AI agents 10. The idea is that given a foundation model for an AI Agent, where any group willing to develop a new LLM project would only need to connect to it, and implement data connectors, documents, algorithms, and possibly fine tuning it.

### AI Platform as a Copilot for User Experience Monitoring

For illustration purposes, the AI agents 10 and the AI platform 50 are described with reference to a user experience monitoring service, such as ZDX available from Zscaler. In the traditional computing model, most users were centrally located under the control and monitoring of IT in an organization. The transformation of hybrid work, cloud, and zero trust has upended this approach. IT is no longer in control and the lack of visibility creates complexity in resolving issues. As such, there are Digital Experience Monitoring (DEM) services which provide visibility across devices, networks, and applications, even outside of IT control, for the detection and resolution of issues and their root causes.

Also, an AI copilot is a tool that can assist a user with a service. It is more helpful than a help guide in that it seeks to support a user in tasks and decision making, such as for context-aware assistance, automation of tasks, data analysis, communication, and the like. Importantly, an objective of a copilot is to reduce the requirement for user expertise. For example, in DEM, the AI copilot could provide answers as well as automate solutions, such as, “my Internet is slow, what should I do?” Those skilled in the art will appreciate the present disclosure contemplates the AI agents 10, the AI platform and the AI copilot in various use cases, i.e., DEM is shown for illustration purpose; other uses are contemplated.

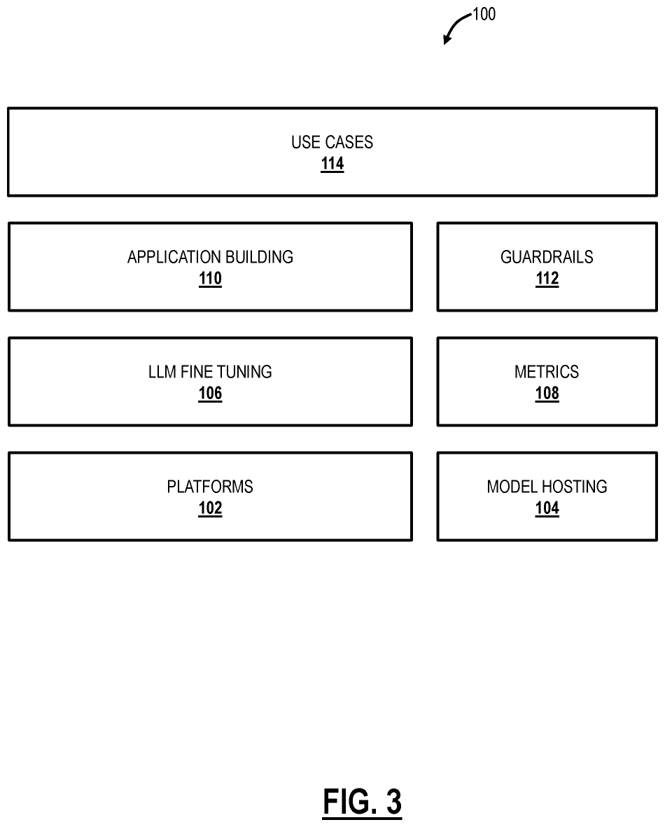

FIG. 3 is a logical diagram of an example AI copilot system 100, which utilizes the AI agents 10 and the AI platform 50. Those skilled in the art will appreciate FIGS. 1-3 are logical diagrams describing functionality. Of course, in implementation and realization, the functionality can be split up, combined, etc. with these FIGS. 1-3 presented as examples. The AI copilot system 100 includes a platform layer 102, a model hosting layer 104, an LLM fine tuning layer 106, metrics 108, an application building layer 110, guardrails 112, and various use cases 114 being serviced.

The platform layer 102 generally includes the compute resources and associated tools, hosting, etc., including commercial offerings as well as in-house developed environments. The model hosting layer 104 provides a servicing functionality to connect, launch, and generally service the models. The LLM fine tuning layer 106 includes LLMs, a fine tuners, training tools and data sets, and the like. The metrics 108 can include various measurement techniques to determine model effectiveness, from the LLM fine tuning layer 106, such as language metrics, ML metrics, alignment metrics, production metrics, etc. The application building layer 110 can include an orchestrator that manages different tools to build applications between the user cases 114 and the models being hosted below. The guardrails 112 ensure valid structure, safety, style, etc. Finally, the use cases 114 can be practically anything, such as assisting in DEM and the like, e.g., see Table 1 above.

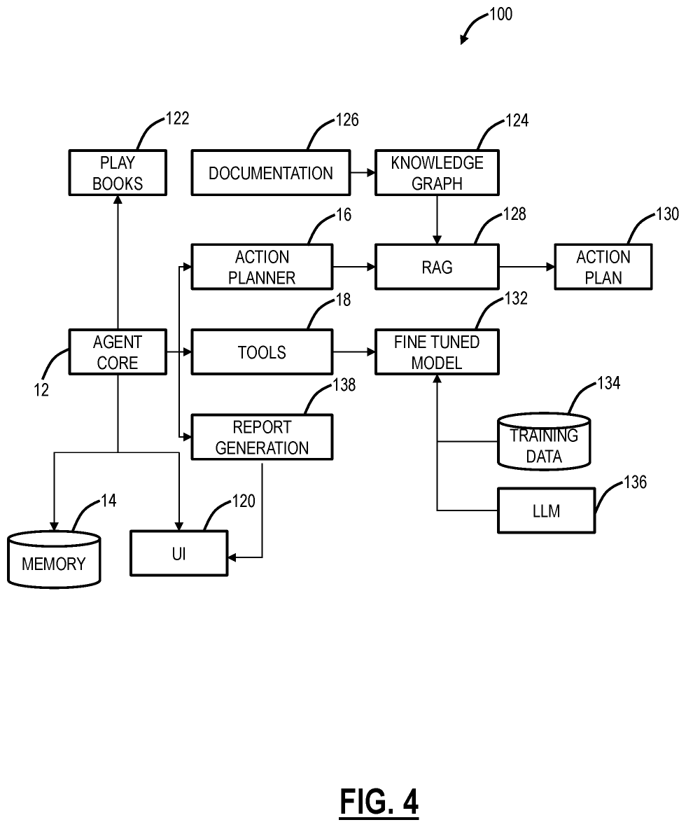

FIG. 4 is a flow diagram of functionality in the AI copilot system 100, in the example use case of user monitoring. FIG. 3 can be seen as a static view of the AI copilot system 100, where FIG. 4 presents a dynamic view, in the example use case of user monitoring. Do note, the AI copilot system 100 expands on the AI agents 10 and the AI platform 50, and includes the agent core 12, the memory 14, the planner 16, and the tools 18. Further, the AI copilot system 100 includes a user interface (UI) 120, playbooks 122, a knowledge graph 124 created from data such as documentation 126, a RAG 128 that develops an action plan 130 from the knowledge graph 124 and the planner 16, etc. The tools 18 include a fine tuning 132 component that can use training data 134 and other LLMs 136.

For the playbooks 122, sometimes, experts have already captured important complex scenarios that need to be executed. Because these playbooks involve complex scenarios that are extremely important to customers (user), we do not want to leave it to the planner to figure out how to execute this task, as we have seen that the accuracy of the planner can degrade exponentially as the number of sub-tasks increases.

For the graphs 124, words are connected to concepts, and, in an example user case of networking, cybersecurity is inferred from a network topology. So, it is important to increase accuracy of results by using concept and network topology graphs in order to better provide context to the planner so that it can perform good planning.

For the guardrails 112, recently a few papers showed that LLMs can leak out training data by asking questions in different ways (in fact, sometimes even simple questions can leak out training data). For example, we were able to get an example model to leak out training data by simply asking: Generate 100 questions similar to “I want to order a Margherita gourmet pizza in 20 minutes.” In addition to that, you want to avoid questions that are not relevant to the domain, bias, racism, and the like. In FIG. 4, the UI 120 can provide an interface for the user to interact, e.g., enter a query, etc., receive a report, action plan, etc.

### Example Operation

Assume a user uses the AI copilot system 100 for the following questions: What happens if I add policy a to my configuration? The following steps can be implemented by the AI copilot system 100:
1. A=retrieve current configuration
2. B=simulate configuration (A)
3. A′=add_policy_to_configuration (A, a)
4. B′=simulate configuration (A′)
5. C=compare (B, B′)
6. Report visualization of results (C)

### LLM is the New UI/UX

The acceleration of LLM model development and their visibility have prompted the genesis of many LLM-based products. Recently, the release of ChatGPT was a milestone that signaled a significant shift in society, including changes in software design paradigms. Initially, LLMs like ChatGPT revolutionized the field with advanced chatbots and AI Agents, enhancing the ability of these models by connecting data sources, algorithms and visualizations to LLMs.

However, there has been a transition towards more sophisticated systems such as Retrieval-Augmented Generation (RAG) and AI Agents. Although more recent LLMs have the capability to do data analysis and even data summarization and representation, the ability to connect to external data sources, algorithms and specialized interfaces to LLMs adds additional flexibility to LLMs by enabling it to perform tasks that involves analysis of domain specific real time data, or even the possibility to perform tasks that are still beyond LLM's capabilities.

Here, there is a discussion of the changes in software design using AI Agents, specifically, the shift from traditional UI/UX user stories in software design to LLM-based AI Agent interfaces implementing several user stories using a single natural language interface. This transition represents a paradigm shift from well-structured documentation of data sources, UI/UX interactions, and algorithms, where you can reasonably well estimate size and effort of development, to a more flexible, albeit imprecise, mode of interaction through natural language descriptions. While this shift has unlocked unprecedented levels of user accessibility and software adaptability, it has also introduced unique challenges. One of the most fundamental questions addressed herein is on how to estimate the development effort and size of these new systems, where the LLM interacts with the user sometimes in unknown ways.

### UI/UX Based System Design and Effort Estimation

In this section we provide a simple example to show how effort can be estimated using current software engineering methods. We emphasize here that knowing the number of data sources, user interface widgets and algorithms enables one to estimate the effort and size of a project or feature.

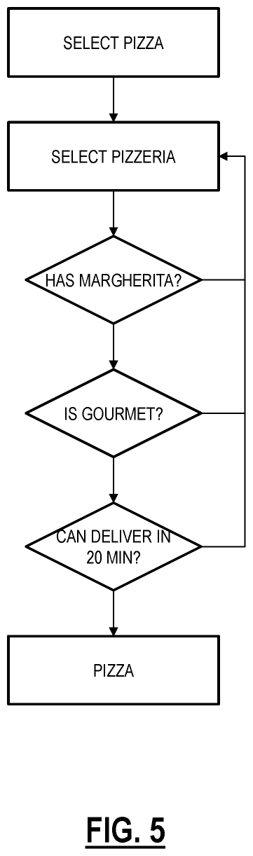

In this example, we want to examine the complexity of adding the user story of ordering a margherita gourmet pizza in 20 minutes to a food app, as an optimization to the flow presented in FIG. 5. We have to assume that to implement this use case, we need access to the following data sources and algorithms:

(1) Restaurant database that can be searched by location and by type of food.

(2) Menu database, where the user can search for types of food served by the restaurant.

(3) Algorithm that computes the delivery time from the restaurant to your location.

Based on this information, and the number of widgets available in the user interface, we can estimate the development effort based on previous experiences. The reader should notice that this use case implements a single type of user interaction, and if we decide to modify the interaction, we will need to change the user story, or create another implementation that accommodates a different user story.

With advent of LLMs in the previous year, we have seen people specifying user stories using natural language, as mentioned before, in the following way: I want to order a gourmet Margherita pizza in 20 minutes.

In user story development, as follow-up questions one would need to document in the development process, we would like to determine.
(1) Which data sources should we connect to?
(2) Which algorithms we need to invoke to solve this request?
(3) Which interfaces are required to implement this user story?
(4) Which other questions we want to be able to solve?

We have seen a deterioration of specification quality in user stories when people over abuse the capabilities of adaptability of LLMs and we will show how we can easily lose control of this simple requirement by just slightly changing the question.
(1) Can this restaurant deliver food in 20 min?
(2) Give me the list of all restaurants that deliver gourmet pizza in 20 min.
(3) Give me the 20 top evaluated restaurants that can deliver gourmet pizza in 20 minutes.

The reader can easily see that the first question requires just a simple yes/no answer. The second question requires a summarization or visualization agent to provide the answer. The third query will require getting data from possibly an additional table for the backend. Without fully specifying what are the problem the system is trying to solve, and resorting to just a single question (as people expect the LLMs to extrapolate automatically on these questions), estimating the development effort may become an almost impossible task.

### Estimating Effort in AI Agents Via the Planner

We can retrieve a similar level of understanding of implementation effort of the user stories if we use the planner 16 of the AI agent system 10 to enumerate the data sources and algorithms we need to use by sampling questions we want to be able to answer with these systems. The idea is presented below by iterating over generation of related questions and asking the planner 16 to generate sub-tasks for the generated set of questions.

```
  Require: List of questions Q
    AllTasks ← Ø
    for q ∈ Q do
      Generate N related questions Q_{q}
      from q. T_{q} ← Planner (
          {q} ∪ Q_{q}, current tools = AllTasks,
          minimize = True)
      for t ∈ T_{q} do
        t[‘task’] ← data source|algorithm|UI widget
      end for
      Manually validate the set T_{q}.
      AllTasks ← AllTasks ∪ T_{q}
end for
    Manually validate final set of AllTasks
```

Once we iterate over sample questions and extract related questions, we should be able to converge on the set of data sources, algorithms and interface items that are required. As an additional piece of information, we will be able to document what the system will do and not do. For example, by documenting which data sources we are accessing, we should be able to document explicitly which data sources we will not be accessing.

Please note that at each step of this procedure, we need users to evaluate the questions generated automatically and the tools required to process the questions, as we may have duplicates, unnecessary tools and hallucinations.

We used the following prompt to generate similar questions to the original question specified as an important user story. This prompt generated the following similar questions in a LLM that the system may be required to process. The reader should note that some of these questions may require use of additional data sources, or execution of different algorithms, or even requiring additional visualization widgets.

For example, the following table 2 can be an example interface in the planner 16:

TABLE 2
General instructions
You are simulating what a user would want to request in a food app. You will
generate 6 related questions to the user request. Each generated question should
cover different aspects of what a user may want to do in a real scenario. Each
aspect should be associated to different data sources, algorithms and interfaces
that needs to be implemented by the app. Your generated questions should be
simple sentences. You should refrain from repeating the same contents in
different questions. Your answer contain the list of generated questions and
nothing more. Your answer should not contain enumerations or itemized lists.
User request
I want to order a gourmet Margherita pizza in 20 minutes

Here are six example related questions:
(1) Can you provide a list of nearby pizzerias that offer gourmet Margherita pizzas with an estimated delivery time of 20 minutes or less?
(2) Are there any ongoing promotions or discounts for a Margherita gourmet pizza available for quick delivery?
(3) What are the options for customizing a Margherita gourmet pizza, such as crust type or cheese options, while still ensuring a 20-minute delivery?
(4) Can you recommend the top-rated restaurant for a gourmet Margherita pizza based on user reviews and delivery speed?
(5) Are there any minimum order requirements or additional fees associated with ordering a single Margherita gourmet pizza for quick delivery?
(6) Can you filter the restaurant search?

Table 3 presents the raw list of tools (data sources, algorithms, and user interface items) that were generated from the algorithm outlined before, based on the prompt of Table 2 enhanced with all the questions with the additional instruction to minimize redundant tasks or tools. It is worth noting that by carefully choosing the planner 16, we will be able to get a much better and curated list of tools.

TABLE 3

| Task | Instruction |
|---|---|
| Algorithm | Algorithm to check the availability of the selected pizza type in |
| | real-time |
| Algorithm | Algorithm to record the new order with a gourmet margherita |
| | pizza and a set time of 20 minutes from the current time |
| Algorithm | Algorithm to manage the countdown and ensure the order is |
| | ready in twenty minutes |
| Algorithm | Algorithm to notify the user when the order is placed, when it |
| | starts being prepared, and when it's ready for delivery or pickup |
| Algorithm | Algorithm to handle payment for the order through the app's |
| | integrated payment system |
| Algorithm | Algorithm to ensure the order is completed and pizza is handed |
| | off for delivery or pickup after twenty minutes |
| Algorithm | Algorithm to filter pizzerias that offer gourmet Margherita pizzas |
| Algorithm | Algorithm to estimate delivery time based on user location and |
| | pizzeria location |
| Algorithm | Algorithm to filter pizzerias with an estimated delivery time of 20 |
| | minutes or lessAlgorithm to check for promotions or discounts |
| | on a specific item |
| Algorithm | Algorithm to determine if quick delivery is available for an item |
| Algorithm | Algorithm that combines CheckPromotionForltem and |
| | ShowPromotionDetails for a specific item |
| Algorithm | Algorithm that combines CheckQuickDeliveryOption and |
| | ShowDeliveryOption for a specific item |
| Algorithm | Filter the customizations applicable to Margherita pizza |
| | Algorithm |
| Algorithm | Algorithm that retrieves restaurants sorted by user ratings and |
| | filters for gourmet Margherita pizza. |
| Algorithm | Algorithm that retrieves restaurant with the fastest delivery |
| | speed for Margherita pizza. |
| Algorithm | Algorithm that recommends the top-rated restaurant for |
| | gourmet Margherita pizza with the fastest delivery. |
| Algorithm | Check availability of Margherita gourmet pizza |
| Algorithm | Calculate total cost for a single Margherita gourmet pizza |
| | including additional fees |
| Algorithm | Provide delivery time estimate for quick delivery option |
| Algorithm | Algorithm to filter restaurant data based on certain criteria |
| Data Store | Database table containing different types of pizzas including |
| | gourmet margherita |
| Data Store | Database table to store information about user orders including |
| | details and timings |
| Data Store | Model containing pizzeria information including location and |
| | menu offerings |
| Data Store | Data source representing promotions or discounts |
| Data Store | Data source representing menu items including pizzas |
| Data Store | Retrieve list of gourmet pizza customizations |
| Data Store | Retrieve delivery times for each customization option |
| Data Store | Data source containing restaurant details including ratings and |
| | reviews. |
| Data Store | Data source containing delivery speed information for |
| | restaurants. |
| Data Store | Retrieve minimum order requirements and additional fees |
| Data Store | Retrieve delivery options, time estimates, and fees for quick |
| | delivery |
| User Interface | Interface to display the PizzaMenu for user selection |
| User Interface | Interface to show confirmation details and allow users to |
| | confirm their order |
| User Interface | Interface to display the real-time status of the order including |
| | the countdown and readiness status |
| User Interface | Interface to display the list of nearby pizzerias that meet the |
| | criteria |
| User Interface | Interface to display promotion details to the user |
| User Interface | Interface to display quick delivery availability to the user |
| User Interface | Show available crust types and cheese options for Margherita |
| | pizza within 20-minute delivery time |
| User Interface | Interface to show the recommended restaurant to the user. |
| User Interface | Show availability, total cost, and delivery time for a single |
| | Margherita gourmet pizza |
| User Interface | Interface to show filtered restaurant results to the user |

You can see that by just using this procedure, we have been able to document the effort to develop this system using 22 algorithms, 11 data sources, and 11 user interfaces, which includes one more user interface for the LLM-based AI Agent.

Accordingly, using an LLM to generate a list of similar questions, and leveraging the planner state of the AI Agent to create a list of non-duplicated sub-tasks, we are able to regain the same level of precision that user stories and use cases had achieved previously. Specifically, the LLM is configured to generate similar questions or paraphrasing, by understanding the semantic meaning of the input question and then creating variations that preserve this meaning while altering the phrasing.

### Next Generation AI Agent System

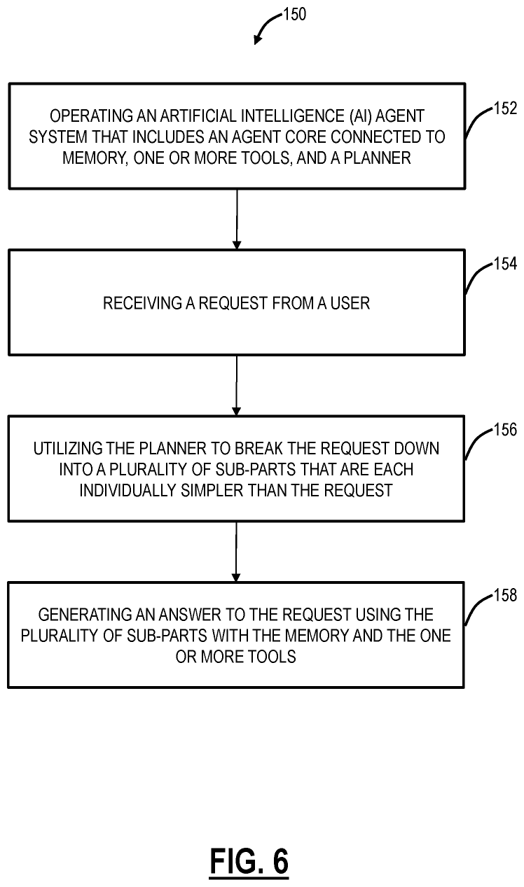

FIG. 6 is a flowchart of an AI agent process 150. The AI agent process 150 contemplates implementation as a method having steps, via a processing device configured to implement the steps, and as a non-transitory computer-readable medium storing instructions that, when executed, cause one or more processors to implement the steps.

The AI agent process 150 includes operating an Artificial Intelligence (AI) agent system that includes an agent core connected to memory, one or more tools, and a planner (step 152); receiving a request from a user (step 154); utilizing the planner to break the request down into a plurality of sub-parts that are each individually simpler than the request (step 156); and generating an answer to the request using the plurality of sub-parts with the memory and the one or more tools (step 158).

The agent core can be a first Large Language Model (LLM) and the planner is a second LLM, different from the first LLM. The memory can include a history memory and a context memory, with the history memory storing a record of previous inputs, outputs, and outcomes of actions taken by the AI agent, and the context memory includes relevant information about a current state. The one or more tools can be configured to perform specific functions based on a defined domain of the AI agent.

The one or more tools can include Retrieval-Augmented Generation (RAG). The RAG can include a plurality of questions and corresponding answers and a plurality of descriptions and corresponding algorithms, where a given answer is provide based on an associated questions and a given algorithm is performed based on an associated description. The agent core can be further configured to implement a given algorithm based on the answer matching the associated description.

The one or more tools can include one or more of a database connection, Natural Language Processing libraries, visualization tools, simulation environments, and monitoring frameworks. The planner can be configured to generate a plurality of related questions based on the request; and determine a plurality of algorithms, data sources, and user interface aspects, based on the plurality of related questions, and provide the plurality of algorithms, the data sources, and the user interface aspects to the agent core for orchestrating the answer. The AI agent system can operate as an assistant to one or more cloud services.

### RAG

A key component is the planner 18. If the planner makes a wrong decision in splitting the tasks, we will get the wrong answer. The planner can be an LLM and its function is to accurately split up a query or the like. One must understand that besides building the infrastructure, we need to integrate the AI agent system 10 to products, for gathering data, curating it, integrating the AI Agent foundation model to the product. Besides the integration, we need to debug and evaluate the performance of the entire system.

In the present disclosure, RAG can be used to generate question and answer pairs for improving AI performance. RAG is the process of optimizing the output of an LLM, so it references an authoritative knowledge base outside of its training data sources before generating a response. LLMs are trained on vast volumes of data and use billions of parameters to generate original output for tasks like answering questions, translating languages, and completing sentences. RAG extends the already powerful capabilities of LLMs to specific domains or an organization's internal knowledge base, all without the need to retrain the model. It is a cost-effective approach to improving LLM output so it remains relevant, accurate, and useful in various contexts.

One of main components is a RAG pipeline which enables you to combine documents and algorithms in the tools 18. In RAG, we index document chunks using embedding technologies in vector databases, and whenever a user asks a question, we return the top-ranking documents to a generator LLM that in turn composes the answer. RAG can include a set of questions and answers (Q, A), as well as pairs of descriptions and algorithms (D, Algo), pairs of topic sentences and paragraphs, and the like.

RAG enables the AI agent system 10, the AI platform 50, and the AI copilot system 100 to add domain-specific details. A domain is the specific function or industry, such as, e.g., DEM in the example above. RAG includes a plurality of tuples and there is a need to document and debug these tuples in the RAG. We use the term tuple to refer to a question/answer pair in RAG (as well as a descriptor/algorithm pair, question/algorithm pair, topic sentence/paragraph pair, etc.) For example, again using user experience monitoring, example tuples can include:
(1) Q=How do I debug a slow connection? A=XXXX
(2) Q=My links is slow, what should I do? A=run=debug_slow_link

We want to be able to answer the following question. Given a query K, and a number of question and answer pairs in a RAG system (Q, A) and a number of descriptions and algorithms pairs (D, Algo), we want to know what are the top-k entries that will map to K.

Specifically, if for a question q in {Q} U {D} (where U is union), if we compute a similar query q′ derived from q using an LLM, what is the probability it will not match q in the top-k answer. This will enable us to debug the system when the number of entries in (Q, A) U (D, Algo) is large. That is, we want to create solution to detect when we know that the AI agent system 10 will probably give the wrong solution because two questions q1 and q2 in {Q} U {D} are very similar.

In an example RAG implementation, we have both (Q, A) pairs and (D, Algo) pairs—visually, e.g.:

TABLE 4

| | |
|---|---|
| Q1 | A1 |
| Q2 | A2 |
| . . . | . . . |
| QX | AX |
| D1 | Algo1 |
| D2 | Algo2 |
| . . . | . . . |
| DY | AlgoY |

In Table 4, there are X question-answer pairs and Y descriptor-algorithm pairs, X and Y are positive integers and they may or may not be equal. Our objective is to automate troubleshooting of these pairs in that similar questions should map to the same answers and similar descriptors should map to the same algorithms. Stated differently, since RAG helps in adding domain expertise in the AI agents, we do not want similar questions to yield different answers. For example, entry (K)→should match entry (Q35), but matched entry (Q99) instead in top-1, top-3, top-5, . . . .

For example—here is a first question (again using networking as an example) While enabling IPv6 settings, what subnets to add in ‘Destination Inclusions for IPv6’ option under App Profile? Similar questions can include
How do I configure the IPv6 destination inclusions for my app profile?
What should I input for the ‘Destination Inclusions for IPv6’ setting in my app's profile?
Can you guide me on setting up the IPv6 destination inclusions in my application?
What are the correct IPv6 subnet entries for the destination inclusion settings of my app?
Could you assist me in determining the IPv6 destinations to include for my app's network settings?
1. Need to evaluate answers to make sure for question Q and answer A, A is a complete answer (middle school style) to Q, because a complete answer can be fed to the generator.
Example: Q: What's the meaning of the world? A: The meaning of the world is 42.
If answers do not have a complete answer, we will need to write a script that creates a complete answer for the pair (Q, A).

### RAG Debugging

The present disclosure includes an automated approach to debugging the pairs in a RAG system, such as using an LLM (e.g., the planner 16) to create N similar questions, N is positive integer, such as, e.g., 100, to a given question Q so we can evaluate if we are going to choose the same (Q, A) pair or not. If we are not, we need to start debugging that sooner.

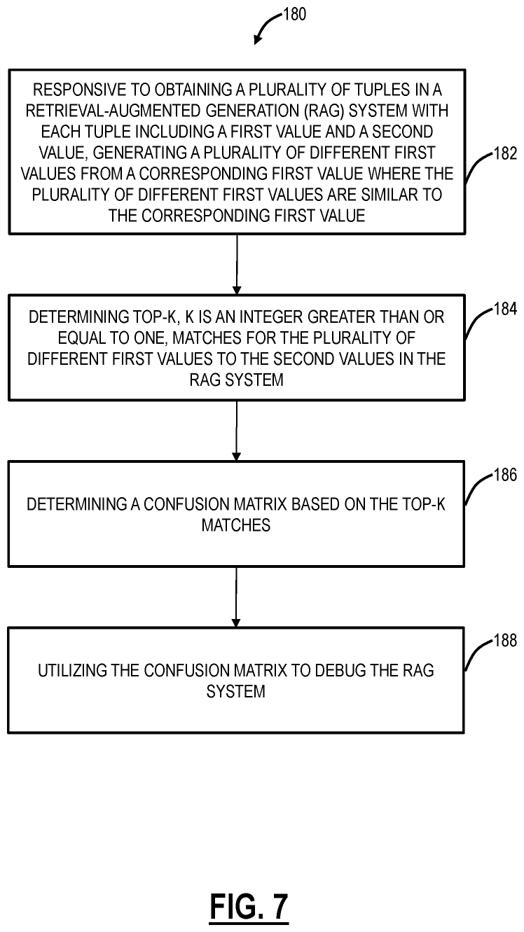

FIG. 7 is a flowchart of a process 180 for detecting and fixing collisions in a RAG system. The process 180 contemplates implementation as a method having steps, via a processing device configured to implement the steps, and as a non-transitory computer-readable medium storing instructions that, when executed, cause one or more processors to implement the steps.

The process 180 includes, responsive to obtaining a plurality of tuples in a Retrieval-Augmented Generation (RAG) system with each tuple including a first value and a second value, generating a plurality of different first values from a corresponding first value where the plurality of different first values are similar to the corresponding first value (step 182); determining top-k, k is an integer greater than or equal to one, matches for the plurality of different first values to the second values in the RAG system (step 184); determining a confusion matrix based on the top-k matches (step 186); and utilizing the confusion matrix to debug the RAG system (step 188).

The tuples are (first value, second value). The first value can be a question and the second value is an answer, based on a domain associated with the RAG system. The first value can be a description and the second value can be an algorithm, based on a domain associated with the RAG system. Also, the first value could be some topic sentence and the second value can be a document, tool, etc. That is, the first value can be some chunk of data and the second value can be some other chunk of data. Further, the plurality of tuples can be a mixture of these different types of values.

Let's assume the first values are represented by q (e.g., questions) in the set Q. The process 180 is generating M different questions and let's call it q′. The generating can be via a Large Language Model (LLM) which is presented with instructions and the first value. The instructions can include a number of the plurality of different values to generate and limitations on the plurality of different values relative to the corresponding first value. The instructions can include limitations on the plurality of different values relative to the corresponding first value, the limitations include a limit on contents from the first value that should be in any of the plurality of different values. For example, the instructions can be a prompt, such as:

“You are simulating what a user would want to do a software. You will generate 6 questions that express the same idea. You should refrain from repeating the same contents in different questions. Your answer contain the list of generated questions and nothing more. Your answer should not contain enumerations or itemized lists.”

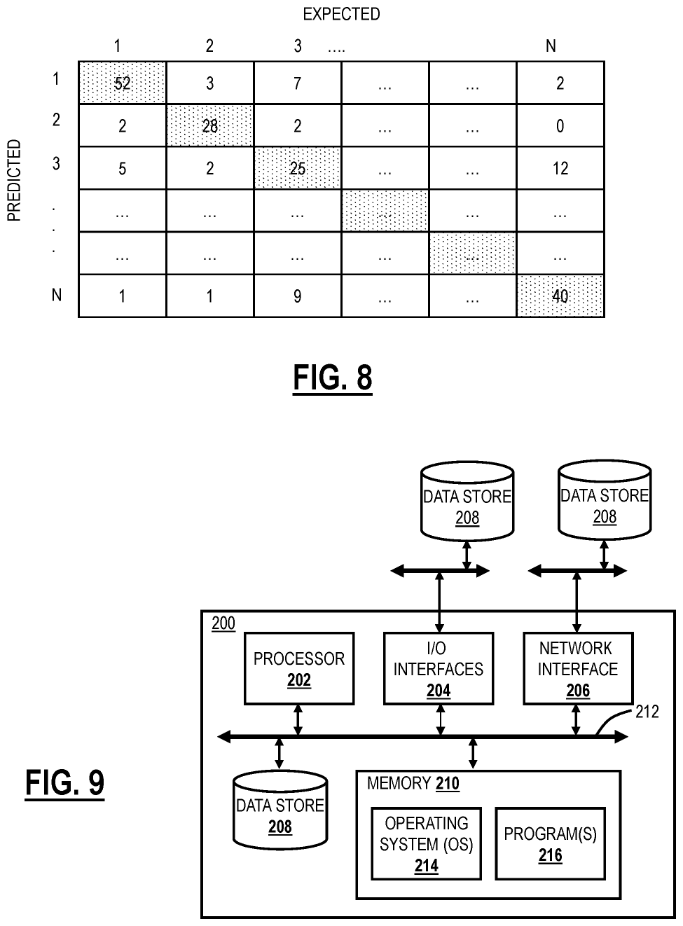

We compute for each q′ the top-k matches for it and we will annotate it if it does not match q. For example, for top-1 and N, we could have the table representation in FIG. 8, which is in machine learning called a confusion matrix. Now, given the confusion matrix, we can compute the accuracy, precision, recall, and F-score. The process 180 can include determining one or more of accuracy, precision, recall, and an F-score using the confusion matrix.

In addition, for each entry that is not correctly matched, we can point to the user the pair (q, q′). For debugging, a user can do one or more of the following in with the pair (q, q′):
a. A Add the entry (q′, a) for a in (q, a), i.e., adding an entry in the plurality of tuples for a different first value that points to a wrong second value.
b. Modify q so that it matches, i.e., modifying an entry for the corresponding first value so that a different first value matches the second value of the corresponding first value.
c. Modify all the k's in {Q} that matched q′ d. Delete q because it should be subsumed by k in Q-{q}.
e. Delete k in Q-{q} because q is a more generic question.
f. Don't know anything (assume it cannot be fix).
g. Change embedding to have better matching.

Because the LLM generated q′ from q, there is a very high chance that the system will fail with slightly modified questions.

Fixing is important for use of any system. Specifically, if we just remove the duplicates (options d and e above), the remaining issues still remain and will cause end users to encounter problems. This debugging process needs to be periodically performed.

### Additional Applications

The examples so far relate to networking. The RAG system can relate to other aspects, such as medical questions and answers. For example, assume the following example:

Original: Does testosterone stimulate adipose tissue 11beta-hydroxysteroid dehydrogenase type 1 expression in a depot-specific manner in children?

Similar: In what ways can testosterone contribute to the development and progression of obesity and related metabolic disorders during childhood?

Matched: Is obesity at diagnosis associated with inferior outcomes in hormone receptor-positive operable breast cancer?

Probably, because you would not probably consider breast cancer in children, if you add the answer to the matched question to the generative LLM of a RAG pipeline, you may be lead it to hallucination.

### Example Debugging

RAG computes embeddings on questions Q to determine the answers A. If we are using document chunks, the Q and A are the same, and if we are using algorithms, Q is the docstring of the function, and A is the function. A key aspect is if we get the wrong Q, the user will not be pleased no matter how good the answer is.

The following pseudocode compares the embeddings for a confusion matrix.

### Assumes:

```
    (q,a) in DB for Q&A,
    (c,c) in DB for chunks,
    (d,f) in DB for functions
confusion_matrix = zeros(|DB|, |DB|)
e_db = [embedding(q) for q in DB(q,a)] # array (|DB|, size)
for each q in DB(q,a):
  generate N questions q′ ~ q using LLM
  for each q′:
    e_qp = embedding(q′) # vector (size)
    k = argmax(dot(e_db, e_qp))
    confusion_matrix[k][index(q)] += 1
    if k != index(q):
      print(Original: q)
      print(Similar: q′)
      print(Matched: k)
```

### Example Processing System Architecture

FIG. 9 is a block diagram of a processing system 200. The processing system 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the processing system 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the processing system 200, a semiconductor-based microprocessor (in the form of a microchip or chipset), or generally any device for executing software instructions. When the processing system 200 is in operation, the processor 202 is configured to execute software stored within the memory 210, to communicate data to and from the memory 210, and to generally control operations of the processing system 200 pursuant to the software instructions. The I/O interfaces 204 may be used to receive user input from and/or for providing system output to one or more devices or components.

The network interface 206 may be used to enable the processing system 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the processing system 200, such as, for example, an internal hard drive connected to the local interface 212 in the processing system 200. Additionally, in another embodiment, the data store 208 may be located external to the processing system 200 such as, for example, an external hard drive connected to the I/O interfaces 204 (e.g., SCSI or USB connection). In a further embodiment, the data store 208 may be connected to the processing system 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

In another embodiment, a cloud system can be configured to implement the various functions described herein. Those skilled in the art will recognize a cloud service ultimately runs on one or more physical processing devices 200, virtual machines, etc. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.”

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, modules, circuits, etc. described herein contemplate use in any and all combinations with one another, including individually as well as combinations of less than all of the various elements, operations, steps, methods, processes, algorithms, functions, techniques, modules, circuits, etc.

What is claimed is:

1. An Artificial Intelligence (AI) agent system comprising:
an agent core;
memory connected to the agent core;
one or more tools connected to the agent core; and
a planner connected to the agent core;
wherein the agent core is configured to:
receive a request from a user;
utilize the planner to break the request down into a plurality of sub-parts that are each individually simpler than the request;
generate an answer to the request using the plurality of sub-parts with the memory and the one or more tools.

2. The AI agent system of claim 1, wherein the agent core is a first Large Language Model (LLM) and the planner is a second LLM, different from the first LLM.

3. The AI agent system of claim 1, wherein the memory includes a history memory and a context memory, with the history memory storing a record of previous inputs, outputs, and outcomes of actions taken by the AI agent, and the context memory includes relevant information about a current state.

4. The AI agent system of claim 1, wherein the one or more tools are configured to perform specific functions based on a defined domain of the AI agent.

5. The AI agent system of claim 1, wherein the one or more tools include Retrieval-Augmented Generation (RAG).

6. The AI agent system of claim 5, wherein the RAG includes a plurality of questions and corresponding answers and a plurality of descriptions and corresponding algorithms, where a given answer is provide based on an associated questions and a given algorithm is performed based on an associated description.

7. The AI agent system of claim 6, wherein the agent core is further configured to implement a given algorithm based on the answer matching the associated description.

8. The AI agent system of claim 1, wherein the one or more tools include one or more of a database connection, Natural Language Processing libraries, visualization tools, simulation environments, and monitoring frameworks.

9. The AI agent system of claim 1, wherein the planner is configured to:
generate a plurality of related questions based on the request; and
determine a plurality of algorithms, data sources, and user interface aspects, based on the plurality of related questions, and provide the plurality of algorithms, the data sources, and the user interface aspects to the agent core for orchestrating the answer.

10. The AI agent system of claim 1, wherein the AI agent system operates as an assistant to one or more cloud services.

11. A method comprising steps of:
operating an Artificial Intelligence (AI) agent system that includes an agent core connected to memory, one or more tools, and a planner;
receiving a request from a user;
utilizing the planner to break the request down into a plurality of sub-parts that are each individually simpler than the request; and
generating an answer to the request using the plurality of sub-parts with the memory and the one or more tools.

12. The method of claim 11, wherein the agent core is a first Large Language Model (LLM) and the planner is a second LLM, different from the first LLM.

13. The method of claim 11, wherein the memory includes a history memory and a context memory, with the history memory storing a record of previous inputs, outputs, and outcomes of actions taken by the AI agent, and the context memory includes relevant information about a current state.

14. The method of claim 11, wherein the one or more tools are configured to perform specific functions based on a defined domain of the AI agent.

15. The method of claim 11, wherein the one or more tools include Retrieval-Augmented Generation (RAG).

16. The method of claim 15, wherein the RAG includes a plurality of questions and corresponding answers and a plurality of descriptions and corresponding algorithms, where a given answer is provide based on an associated questions and a given algorithm is performed based on an associated description.

17. The method of claim 16, wherein the agent core is further configured to implement a given algorithm based on the answer matching the associated description.

18. The method of claim 11, wherein the one or more tools include one or more of a database connection, Natural Language Processing libraries, visualization tools, simulation environments, and monitoring frameworks.

19. The method of claim 11, wherein the planner is configured to:
generate a plurality of related questions based on the request; and
determine a plurality of algorithms, data sources, and user interface aspects, based on the plurality of related questions, and provide the plurality of algorithms, the data sources, and the user interface aspects to the agent core for orchestrating the answer.

20. The method of claim 11, wherein the AI agent system operates as an assistant to one or more cloud services.
